(19) United States
(12) Patent Application Publication
(10) Pub. No.: US 2025/0309414 A1
(43) Pub. Date: Oct. 2, 2025

(54) MOULDED ELEMENT, ENERGY STORAGE DEVICE, STRUCTURAL COMPONENT AND METHOD FOR MANUFACTURING A MOULDED ELEMENT

(71) Applicant: ElringKlinger AG, Dettingen (DE)

(72) Inventors: Matthias BIEGERL, Neuffen (DE); Thomas WOLF, Göppingen (DE); Stefan DIETERLE, Eislingen (DE); Eugen KÜBLER, Owen (DE)

(73) Assignee: ElringKlinger AG, Dettingen (DE)

(21) Appl. No.: 19/237,732

(22) Filed: Jun. 13, 2025

Related U.S. Application Data
(63) Continuation of application No. PCT/EP2023/082268, filed on Nov. 17, 2023.

(30) Foreign Application Priority Data
Dec. 16, 2022 (DE) 10 2022 133 622.0

(51) Int. Cl. H01M 50/112; B29C 44/02; B29C 44/44; B29K 77/00; B29K 105/04; B29L 31/00

(52) U.S. Cl. CPC H01M 50/112; B29C 44/02; B29C 44/445; B29K 2077/00; B29K 2105/048; B29K 2995/0063; B29L 2031/7146; H01M 2220/20

(57) ABSTRACT

A molded element for arranging on a temperature-controllable element, wherein the temperature-controllable element may preferably be an energy storage element, for example an electrochemical energy storage cell, wherein the molded element comprises: at least one receiving zone for receiving at least one section of the temperature-controllable element in the molded element and a molded element material having a density of at most 0.75 g/cm³, preferably at most 0.65 g/cm³, particularly preferably at most 0.55 g/cm³.

### RELATED APPLICATION

This application is a continuation of international application No. PCT/EP2023/082268 filed on Nov. 17, 2023, and claims the benefit of German application No. 10 2022 133 622.0 filed on Dec. 16, 2022, which are incorporated herein by reference in their entirety and for all purposes.

### FIELD OF DISCLOSURE

The present invention relates to the technical field of temperature control, especially the technical field of temperature control of energy storage devices, for example temperature control of electrochemical energy storage devices for the propulsion of motor vehicles.

### BACKGROUND

A very wide variety of proposals have been made for increasing the efficiency and range of fully or partly electrically propelled motor vehicles.

Efforts are being made to the configure the temperature control of electrochemical energy storage devices, especially the cooling thereof, in such a way that it requires as little energy as possible and at the same time does not unnecessarily increase the mass of the motor vehicle. This allows a larger proportion of the energy storable in the energy storage device to be used directly to propel a motor vehicle which is as light as possible. However, there is still a great need for improvement in this regard.

### SUMMARY OF THE INVENTION

It is an object of the present invention to provide an efficient energy storage device and/or a component therefor in the simplest possible way.

According to the invention this object is achieved by a molded element according to the independent claim relating thereto.

The molded element is a molded element for arranging on a temperature-controllable element. This may especially mean that the molded element is suitable for arranging on a temperature-controllable element.

The temperature-controllable element may especially be any element which in proper use may or must have heat supplied to it or removed from it. The temperature-controllable element may thus be an element to be temperature-controlled, in particular an element to be temperature-controlled during proper use.

The temperature-controllable element may preferably be an energy storage element. The energy storage element may especially be a storage element suitable for storing electrical energy.

The energy storage element may preferably be an electrochemical or electrophysical energy storage cell, for example an electrochemical energy storage cell.

The electrophysical energy storage cell may be a capacitor cell for example.

The electrochemical energy storage cell may advantageously be a battery cell, for example a rechargeable lithium-ion battery cell.

It goes without saying that the molded element for arranging on a temperature-controllable element is simultaneously suitable for arranging on further temperature-controllable elements. The molded element may particularly advantageously be a molded element for arranging on a multiplicity of temperature-controllable elements.

In connection with the invention it was found that the molded element is particularly advantageously employable as a displacer body in an electrochemical energy storage device with immersive cooling. The immersive cooling may be carried out using a temperature-control fluid, especially using a temperature-control liquid, for example using a dielectric oil. It is thus possible to reduce the volume of temperature-control fluid required in a housing of the energy storage device while simultaneously achieving weight optimization.

The invention is based on the further considerations of allowing simple positioning and/or securing of energy storage elements in an energy storage device and allowing simple configuration and adaptation of the position and shape of a temperature-control zone that allows efficient temperature-control of energy storage elements.

It may be particularly advantageous when the molded element is a plastic molded element. The plastic molded element may be composed entirely or partially of plastic. The plastic molded element may preferably be composed of plastic to an extent of at least 50% by weight, advantageously to an extent of at least 60% by weight, especially to an extent of at least 70% by weight, particularly preferably to an extent of at least 80% by weight, for example to an extent of at least 90% by weight. The reported weight fractions refer to the mass of the molded element.

The molded element, for example plastic molded element, may be a molded element, for example plastic molded element, obtainable or obtained by molding, for example by injection molding.

The molded element, for example plastic molded element, may be a molded element, for example plastic molded element, obtained or obtainable by a process according to the invention.

The molded element may preferably comprise:
at least one receiving zone for receiving at least one section of the temperature-controllable element in the molded element; and
a molded element material having a density of at most 0.75 g/cm³, preferably at most 0.65 g/cm³, particularly preferably at most 0.55 g/cm³.

The molded element may preferably comprise at least two receiving zones for receiving respective sections of at least two temperature-controllable elements in the molded element, for example a multiplicity of receiving zones for receiving respective sections of a multiplicity of temperature-controllable elements in the molded element.

The term “multiplicity” may advantageously refer to a number of at least 10, preferably at least 50, particularly preferably at least 200, for example at least 250.

The term “multiplicity” may advantageously refer to a number of at most 100 000, for example at most 50 000.

Contemplated receiving zones include any depression in a molded element which is large enough to allow a section of a temperature-controllable element to rest in it. In the receiving zone the molded element material may have a cutout in order that a section of a temperature-controllable element can rest in the cutout.

The molded element and especially the receiving zone make it possible to entirely or completely dispense with cell holders or other auxiliary means which are often employed to arrange energy storage elements in energy storage devices.

It may be advantageous when the at least one receiving zone is configured such that a section of the temperature-controllable element receivable in the receiving zone is surrounded by the molded element material, for example surrounded on all sides by the molded element material, when the section is received in the receiving zone.

It may be particularly advantageous when the at least one receiving zone for receiving at least one cylindrical or prismatic section of the temperature-controllable element is formed in the molded element. The cylindrical or prismatic section of the temperature-controllable element may be a cylindrical or prismatic section of an energy storage element, for example of a cylindrical or a prismatic electrochemical energy storage cell.

The molded element material may preferably be a molded element plastic material.

The molded element may advantageously be used for arranging on the temperature-controllable element.

The molded element for arranging on the temperature-controllable element may particularly advantageously be used in such a way that a temperature-control fluid is at least partially displaced by the molded element.

The temperature-control fluid described herein is preferably a temperature-control liquid, especially a dielectric temperature-control liquid, for example a dielectric oil.

The invention makes it possible to achieve a weight optimization. The weight optimization is very pronounced especially when the density of the molded element material is markedly lower than the density of the temperature-control fluid.

The molded element may particularly advantageously be used for partial displacement of a temperature-control fluid in an energy storage device, for example for partial displacement of a temperature-control fluid in an electrochemical energy storage device.

The density of the molded element material may particularly preferably be at most 0.55 g/cm³. It may be exceptionally preferable when the density of the molded element material is at most 0.50 g/cm³, for example at most 0.45 g/cm³.

The density of the molded element material is generally at least 0.003 g/cm³, for example at least 0.01 g/cm³.

The density of the molded element material may be determined for example by initially removing a portion of the molded element material. The portion of the molded element material that may be removed to determine the density may for example be a cuboid of defined edge lengths. The volume of this portion may be calculated and the mass of this portion determinable by weighing may be divided by the calculated volume.

The molded element may be partially or completely composed of the molded element material.

It may be advantageous when the molded element material occupies at least 50% of the volume of the molded element, preferably at least 70% of the volume of the molded element, for example at least 90% of the volume of the molded element. The molded element material may advantageously occupy for example at least 95% of the volume of the molded element, exceptionally preferably 100% of the volume of the molded element.

The volume of the molded element is delimited by the surface contour of the molded element. The volume of the molded element does not include depressions, for example receiving zones.

The molded element may be a molded element formed from the molded element material.

If the molded element material occupies less than 100% of the volume of the molded element the molded element may advantageously comprise a layer in addition to the molded element material. A layer may for example contribute to preventing penetration of temperature-control liquid into cavities of the molded element material in case the molded element material comprises open cavities accessible to temperature-control fluid.

It is possible for a layer comprised by the molded element to contain an electrically conductive material or to consist of an electrically conductive material. The layer may preferably contain aluminum, for example an aluminum foil. This may be advantageous since this makes it possible for the molded element to additionally achieve an at least partial electromagnetic shielding.

The molded element material may preferably be in a layer composite with the layer.

It may be advantageous when a lowest material thickness of the molded element material is at most 4 mm, especially at most 3 mm, preferably at most 2 mm, particularly preferably at most 1.5 mm, for example at most 1.4 mm. The lowest material thickness may especially be a lowest material thickness that the molded element material comprises between immediately adjacent receiving zones.

It may be particularly advantageous when the density of the molded element material and the lowest material thickness of the molded element material are sufficiently low to achieve a fineness of the molded element calculated by multiplying the density with the lowest material thickness of at most 0.15 g/cm², especially at most 0.12 g/cm², preferably at most 0.10 g/cm², particularly preferably at most 0.08 g/cm², for example at most 0.075 g/cm².

It may be exceptionally advantageous when the fineness is at most 0.06 g/cm², for example at most 0.035 g/cm². Low material thicknesses make it possible to use the molded element to precisely position energy storage elements very close to one another in an energy storage device. A minimum distance between two adjacent energy storage elements may be controlled via a lowest material thickness for example when the lowest material thickness of the molded element is present in a section of the molded element which extends between the energy storage elements.

Observing the described fineness can also ensure that the greatest possible weight saving is achieved.

The density of the molded element material may be sufficiently low, and the molded element material may undergo sufficient narrowing between at least two immediately adjacent receiving zones, to achieve a fineness of at most 0.15 g/cm², especially at most 0.10 g/cm², preferably at most 0.08 g/cm², for example at most 0.075 g/cm². It may be exceptionally advantageous when the fineness thus achieved is at most 0.06 g/cm², for example at most 0.035 g/cm².

The number of the receiving zones comprised by the molded element may be advantageously at least two and the lowest material thickness may be a lowest material thickness measured between two immediately adjacent receiving zones, for example these two receiving zones.

This especially allows the invention to contribute to the achievement of both uniform distances between the energy storage units in an energy storage device and a marked weight optimization at the minimum distance of energy storage units. The exact observance of the distances may especially be important for homogeneous temperature control of the energy storage elements. Undercutting a minimum distance between energy storage elements can have the result that compared to other energy storage elements of an energy storage device these energy storage elements experience poorer temperature control since undercutting a minimum distance between these energy storage elements can cause a temperature-control fluid flow to be largely suppressed, thus favoring unwanted overheating of these energy storage units arranged too close to one another. This can impair the service life of the entire energy storage device and also the operating safety of the energy storage device. The invention can counter this in a particularly simple fashion.

It may be particularly advantageous when the molded element is a flat molded element and the lowest material thickness is measured in a central plane of the flat molded element, wherein the central plane divides the flat molded element into two halves which each occupy a volume of 50% of the volume of the molded element.

The central plane is a notional plane that is used merely to define the molded element. A normal to the central plane may especially extend parallel to a receiving direction, wherein the receiving direction is the direction along which a temperature-controllable element may be introduced into the at least one receiving zone.

The flat molded element may preferably be a flat molded element having a multiplicity of receiving zones and a multiplicity of wall zones, wherein the wall zones in each case delimit adjacent receiving zones relative to one another.

It may be advantageous when the molded element is a flat molded element and the lowest material thickness is measured orthogonally to a central plane of the flat molded element, wherein the central plane divides the flat molded element into two halves which each occupy a volume of 50% of the volume of the molded element.

A cross section of the at least one receiving zone may be round, rectangular or rectangular with rounded corners, wherein the cross section may preferably be a cross section of the at least one receiving zone in the central plane.

The possibility that the cross section is rectangular or rectangular with rounded corners includes the possibility of a cross section that is square or square with rounded corners.

Such cross sections of the at least one receiving zone allow the receiving of cylindrical and prismatic energy storage elements. Prismatic energy storage elements have a cross section that is rectangular with rounded corners.

If the molded element comprises at least two or a multiplicity of receiving zones, the foregoing regarding the cross section may preferably apply to a plurality of the receiving zones, for example for all receiving zones.

The molded element may advantageously be a flat molded element, wherein a circumferential edge of the flat molded element defines a molded element total area and inside the circumferential edge the molded element has receiving zones whose receiving zone total area is at least 75%, for example at least 80%, of the molded element total area.

In the present document a molded element is especially referred to as a flat molded element when a maximum extent of the molded element in a first spatial direction and a maximum extent of the molded element in a second spatial direction are in each case three times as large as a maximum extent of the molded element in a third spatial direction, wherein the second spatial direction is preferably orthogonal to the first spatial direction and the third spatial direction is preferably orthogonal to the first spatial direction and orthogonal to the second spatial direction.

For evaluation of whether a molded element is a flat molded element it is immaterial if the molded element is not closed over its surface since it may have receiving zones which extend through the molded element for example.

The circumferential edge of the flat molded element encompasses the molded element total area.

The receiving zone total area may be an area encompassed by the receiving zones in the central plane.

If the receiving zone total area is at least 75%, for example at least 80%, of the molded element total area this has additional advantages in respect of energy density and temperature control. Having regard to energy density and temperature control it may be desirable when such a large proportion of the area is occupied by the energy storage elements.

It may be advantageous if the at least one receiving zone narrows in a receiving direction in which the temperature-controllable element is receivable in the receiving zone. This may especially contribute to the even simpler provision of an energy storage device since energy storage elements are more easily receivable in the receiving zones in the case of such narrowings.

It may be particularly advantageous when the molded element material comprises cavities. The cavities may be pores for example.

It is very particularly advantageous when at least a portion of the cavities, for example of the pores, may be closed and/or inaccessible to a temperature-control fluid. There may preferably be a physical barrier made of molded element material which prevents penetration of temperature-control fluid into inaccessible cavities. The cavities, for example pores, which are inaccessible to the temperature-control fluid may be enclosed in the molded element material.

It may be particularly advantageous when the molded element material contains particles and the particles comprise cavities, for example pores.

The term “particle” may for example refer to a particle of the molded element material. The particles are not limited in terms of their shape.

The particles may have an irregular or approximately regular shape. They may be substantially round or angular.

The particles may be elongate. This may especially mean that an extent of the particles in a first direction is markedly greater than extents of the particles in a second and in a third direction.

The particles may be flat. This may especially mean that an extent of the particles in a first direction and in a second direction is in each case markedly greater than an extent of the particles in a third direction.

The particles may be compact. This may especially mean that the extents of the particles in a first, a second and a third direction are each similar.

The directions used to describe the shape of the particles may in each case preferably enclose an angle of 90° to one another.

The particles may be granules, beads and/or shaped beads for example. The particles may entirely or partially consist of a foam material.

It goes without saying that the foregoing relating to the shape of the particles and their constitution may also apply to microparticles described herein.

It is very particularly advantageous when at least a portion of the cavities, for example of the pores, may be closed and/or inaccessible to a temperature-control fluid. At least a proportion of the particles may preferably comprise a physical barrier made of particle material which prevents penetration of temperature-control fluid into inaccessible cavities. The cavities, for example pores, which are inaccessible to temperature-control fluid may be enclosed in a particle material.

It is preferable when the molded element material may be a molded element plastic material and the molded element plastic material may contain plastic particles, wherein the plastic particles have cavities, for example, pores.

It is very particularly advantageous when at least a portion of the cavities, for example of the pores, may be closed and/or inaccessible to a temperature-control fluid. At least a proportion of the plastic particles may preferably have a physical barrier made of plastic material which prevents penetration of temperature-control fluid into inaccessible cavities. The cavities, for example pores, which are inaccessible to temperature-control fluid may be enclosed in a plastic material.

The particles, for example the plastic particles, may be microparticles, for example plastic microparticles. A microscopically determinable average particle size may preferably be in the range from 1 μm to 1000 μm, advantageously in the range from 1 μm to 300 μm.

The microscopic determination may preferably be carried out in a section of the molded element material by microscopic examination of the section surface. The average particle size may be approximated by determining an average diameter of the optionally intersected particles visible in the section surface.

It may be particularly advantageous when the molded element material is a particle foam material. The molded element plastic material may for example be a plastic particle foam material.

Particle foam materials have long been known and are extensively described in the literature, for example in Ullmann's “Encyclopedia of Technical Chemistry”, 4th edition, volume 20, pp. 416 ff.

The molded element plastic material may especially be a plastic microparticle foam material.

The plastic microparticles comprised by the plastic microparticle foam material may have cavities, for example pores. At least a portion of the cavities, for example pores, may be enclosed by the molded element plastic material and thus be inaccessible to temperature-control fluid.

Particle foam materials are also known to those skilled in the art as particle foams.

It may be particularly advantageous when the molded element material contains a particle foam. It may be particularly advantageous when the molded element plastic material contains a plastic particle foam.

The plastic particle foam may preferably be a plastic microparticle foam.

The particles having cavities described herein may have one or more cavities per particle. The particles having cavities described herein may be single-celled particles or multi-celled particles or a mixture of single-celled and multi-celled particles. Single-celled and multi-celled plastic microparticles are described for example in U.S. Pat. No. 3,615,972.

In the context of the present invention the term plastic is to be understood as meaning “thermoplastic”.

The plastic molded element is preferably a thermoplastic molded element.

The plastic material is preferably a thermoplastic material. The molded element plastic material is preferably a molded element thermoplastic material. The plastic particle foam material is preferably a thermoplastic particle foam material.

The plastic particle foam is preferably a thermoplastic particle foam. The plastic microparticle foam is preferably a thermoplastic microparticle foam.

The plastic particles are preferably thermoplastic particles. The plastic microparticles are preferably thermoplastic microparticles.

It may be advantageous when particles of the molded element material or of the particle foam material or plastic particles of the molded element plastic material comprise a bonding auxiliary, preferably on their outer surfaces. The bonding auxiliary may comprise bonding auxiliary particles, in particular polymer particles, for example resin particles. The particles or plastic particles having the bonding auxiliary may preferably have bonding auxiliary particles on their outer surfaces. It may be advantageous
when particles or plastic particles are bonded or bondable to one another using the bonding auxiliary
   and/or
when particles or plastic particles are bondable at the receiving zone to the at least one section of the temperature-controllable element using the bonding auxiliary.

The plastic, especially the plastic of the molded element plastic material and/or of the plastic particles, may preferably be a polyamide (PA for short). The polyamide may preferably be selected from:
aliphatic polyamides, for example polyamide composed of ¿-caprolactam, especially polycaprolactam (PA 6 for short), polyamide composed of hexamethylenediamine and adipic acid (PA 6.6 for short) or polyamide composed of hexamethylenediamine and sebacic acid (PA 6.10 for short),
semiaromatic polyamides, which may be for example be synthesized from monomers derived partly from aromatic basic structures and partly from aliphatic basic structures, for example polyamide composed of hexamethylenediamine and terephthalic acid (PA 6T for short),
homopolyamides, wherein the homopolyamide may be derived for example from an aminocarboxylic acid, a lactam or from a diamine and a dicarboxylic acid, for example PA 6 or PA 6.6,
copolyamides, wherein the copolyamide may be derived for example from multiple different monomers, for example polyamide composed of caprolactam,
hexamethylenediamine and adipic acid (PA 6/66 for short) or polyamide composed of hexamethylenediamine, adipic acid and sebacic acid (PA 66/610 for short) and
mixtures of at least two of the recited polyamides, for example of a copolyamide and a homopolyamide.

It may be advantageous when the bonding auxiliary is selected from bonding auxiliaries which allow bonding of the particles or plastic particles to one another or to the at least one section of the temperature-controllable element at a temperature at which the particles or plastic particles are stable. It may be advantageous when the bonding of the particles or plastic particles to one another or to the at least one section of the temperature-controllable element is mediated by the formation of chemical, especially covalent, bonds.

The bonding auxiliary, for example the bonding auxiliary particles, may be functionalized to this end, for example with bonded structural elements. The bonded structural elements may allow the formation of chemical bonds, especially covalent bonds, which are capable of mediating the bonding of the particles or plastic particles to one another or to the at least one section of the temperature-controllable element, or be involved in such chemical bonds, especially covalent bonds.

For example the bonding auxiliary may be a 2-component bonding material which may especially comprise or consist of a resin particle component and a hardener component. The bonding auxiliary particles may especially comprise or be resin particles of the resin particle component.

2-component bonding materials are known to those skilled in the art from 2-component adhesives for example. Combinations of functionalized resin particle components and hardener components known from the field of 2-component adhesives may be used as a bonding auxiliary described herein.

It may be advantageous when the bonding auxiliary is or comprises a thermoplastic, for example a polyamide. The bonding auxiliary may be or comprise for example a thermoplastic, for example a polyamide, which softens and/or melts and/or is amenable to adhesive bonding at a lower temperature than the polyamide of the molded element plastic material and/or the plastic particles.

The polyamide of the bonding auxiliary may also be selected from the aforementioned polyamides or mixtures thereof.

It may be particularly advantageous when a proportion of the cavities, for example of the pores, is closed and/or inaccessible to a temperature-control fluid.

It may be particularly advantageous when a proportion of the cavities, for example of the pores, is open and/or accessible to a temperature-control fluid.

For example, a proportion of the cavities, for example of the pores, may be closed and/or be inaccessible to a temperature-control fluid. Another proportion of the cavities, for example of the pores, may be open and/or be accessible to a temperature-control fluid.

It may be very particularly advantageous when cavities, for example pores, of the molded element material which are closed and/or inaccessible to a temperature-control fluid are surrounded by cavities, for example pores, of the molded element material which are open and/or accessible to a temperature-control fluid.

It may for example be advantageous when the molded element material is a particle foam material and/or contains particles, wherein at least a portion of the cavities, for example pores, of the molded element material which are open and/or accessible to a temperature-control fluid extends around the particles and the particles comprise at least a portion of the cavities, for example pores, which are closed and/or inaccessible to a temperature-control fluid.

It may be advantageous when the molded element material, for example the molded element plastic material, is double-pored. This may especially mean that the molded element material has a proportion of cavities, for example pores, which is closed and/or inaccessible to a temperature-control fluid and a proportion of cavities, for example pores, which is open and/or accessible to a temperature-control fluid. This may alternatively mean in particular that the molded element material has a proportion of cavities, for example pores, which is disposed inside particles of the molded element material and a proportion of cavities, for example pores, which extends around particles of the molded element material.

It may be particularly advantageous when the molded element is permanently resistant to at least one dielectric temperature-control fluid.

The term “dielectric temperature-control fluid” may especially be understood as meaning “dielectric temperature-control liquid”, preferably “dielectric oil”.

The molded element may be considered permanently resistant to a dielectric temperature-control fluid when the molded element is not attacked, for example dissolved, softened or swelled, by this temperature-control fluid. The molded element may be dissolved by a temperature-control fluid especially if a molded element material is completely or partially dissolvable in the temperature-control fluid. The molded element may be softened or swollen by a temperature-control fluid especially when the temperature-control fluid or a constituent of the temperature-control fluid is soluble in the molded element material or at least a proportion of the temperature-control fluid is absorbed by the molded element.

The molded element may be considered permanently resistant to a dielectric temperature-control fluid for example when at least one of the following conditions (a) or (b) is met having regard to this dielectric temperature-control fluid:
(a) the stiffness of the molded element is substantially unchanged after 168 hours of exposure to the temperature-control fluid held at 60° C.,
(b) the compressibility of the molded element is substantially unchanged after 168 hours of exposure to the temperature-control fluid held at 60° C.

The molded element may be considered permanently resistant to the dielectric temperature-control fluid for example especially when both conditions (a) and (b) are met having regard to this dielectric temperature-control fluid.

The exposure may preferably be an exposure where at least all of the surface regions of the molded element which come into contact with the temperature-control fluid in proper use of the molded element, for example in an energy storage device, are in contact with the temperature-control fluid.

The respective property, i.e. the stiffness and/or the compressibility, may be considered substantially unchanged when as a result of the exposure to the temperature-control fluid held at 60° C. for 168 hours it changes by at most 50%, for example by at most 25%. The respective property may be measured for example at 20° C. before and after exposure, wherein after exposure the molded element is held at 20° C. until the whole molded element has cooled to this temperature.

A force applied to effect torsion of the molded element for example may be considered indicative of the stiffness of the molded element. For example, two opposite ends or edges of the molded element may be twisted by 3 degrees relative to one another and the applied force required therefor before and after exposure may be compared.

A force applicable to effect compression of the molded element for example may be considered indicative of the compressibility of the molded element. For example a piston which is placed around a receiving zone on a surface of the molded element may be pressed into the molded element down to a certain depth which may be for example 5% of a thickness of the molded element at the receiving zone and the force applicable therefor before and after exposure compared. The applicable force may be determined at one receiving zone before exposure and at another receiving zone after exposure.

A characteristic considered indicative of whether a molded element is permanently resistant to at least one dielectric temperature-control fluid may be for example whether the molded element is permanently resistant to one of the following comparative temperature-control liquids: monoethylene glycol and decane. Decane is lipophilic. Monoethylene glycol is hydrophilic.

It may be very particularly advantageous when the molded element is permanently resistant to at least these two comparative temperature-control liquids.

These two comparative temperature-control liquids are particularly suitable for testing. They may be regarded as representative for many commercially available temperature-control liquids with respect to their hydrophilicity and lipophilicity—and thus with respect to their effect on typical molded element materials.

It may be advantageous when the molded element is sealed.

By way of example, a sealing composition which in proper use of the molded element, for example in an energy storage device, comes into contact with a temperature-control fluid may be arranged on at least one surface region of the molded element.

It may be advantageous when the molded element is sealed such that the sealed molded element has a higher resistance to the at least one dielectric temperature-control fluid than the unsealed molded element. This may be tested according to the above-described procedure.

It may be advantageous when the molded element comprises an adhesion promoter at least in one receiving zone. The adhesion promoter can advantageously improve or promote the adhesion of the at least one section of the temperature-controllable element to the molded element.

It may be advantageous when the molded element is sealed with the adhesion promoter.

According to the invention, the object is achieved by an energy storage device according to the independent claim relating thereto.

The energy storage device may especially be an electrochemical or an electrophysical energy storage device.

The energy storage device is preferably an electrochemical energy storage device.

The energy storage device may be a battery device for example.

It goes without saying that the energy storage devices, electrochemical energy storage devices, battery devices, energy storage elements, electrochemical energy storage cells and battery cells mentioned herein are preferably rechargeable.

The energy storage device may especially comprise:
at least one energy storage element, preferably at least one electrochemical energy storage cell, for example at least one battery cell; and
at least one molded element according to the invention,
   wherein at least one section of the at least one energy storage element is received in the at least one receiving zone of the molded element.

The energy storage device may preferably comprise a plurality of energy storage elements. It is preferable when at least one section of each energy storage element may be received in a respective receiving zone of the molded element.

The section of an energy storage element which is received in a receiving zone of the molded element is also referred to as the received section.

The energy storage device may advantageously comprise a temperature-control zone in which a temperature-control fluid may be conducted.

A received section of the at least one energy storage element may be received in the at least one receiving zone of the molded element and a temperature-control section of the at least one energy storage element may extend into the at least one temperature-control zone or through the at least one temperature-control zone.

The molded element may then especially occupy a space which, without the molded element, would be traversable by the temperature-control fluid. The temperature-control zone would then be larger and the mass of the temperature-control fluid conductible within the energy storage device would be correspondingly greater.

The at least one energy storage element may preferably be joined to the at least one molded element by an atomic-level join.

When the energy storage device comprises a plurality of energy storage elements a plurality of the energy storage elements may preferably be joined to the at least one molded element by an atomic-level join. All energy storage elements may then preferably be joined to the at least one molded element by an atomic-level join.

It may be particularly advantageous when the at least one energy storage element is joined to the at least one molded element by an atomic-level join, wherein the received section may preferably be joined to the receiving zone by an atomic-level join.

When the energy storage device comprises a multiplicity of energy storage elements that are joined to the at least one molded element by an atomic-level join the respective received sections of the multiplicity of energy storage elements may preferably each be joined to a respective receiving zone by an atomic-level join.

It may be particularly advantageous when the molded element is a molded element according to the invention described herein and particles or plastic particles of the molded element are joined at the receiving zone to the at least one section of the temperature-controllable element by means of the bonding auxiliary.

The atomic-level join may particularly advantageously be an indirect atomic-level join. The indirect atomic level join may preferably be mediated by a potting compound and/or an adhesion promoter.

The potting compound and/or the adhesion promoter may preferably contain a resin material. The resin material may be an epoxy resin material, a phenolic resin material, an aminoplast material, a polyurethane material, a silicone material, a polyester resin material or an ABS (acrylonitrile-butadiene-styrene) resin material.

The indirect atomic-level join may alternatively be mediated by a material distinct from a potting compound. The material may be an adhesive for example.

It is possible for the indirect atomic-level join to be mediated by a potting compound or by an adhesive.

It may be particularly advantageous when the at least one energy storage element is joined to the at least one molded element by an atomic-level bond via a layer, for example potting compound layer, arranged on a surface of the at least one molded element, wherein the layer, for example potting compound layer, extends to a surface of the at least one energy storage element. This makes it possible in simple fashion by application of potting compound to produce an atomic-level fluid-tight join while simultaneously effecting a sealing of a temperature-control zone.

It may be advantageous when the receiving zone narrows around the section of the at least one energy storage element received in the at least one receiving zone of the molded element and a space between the energy storage element and the molded element which narrows in the receiving zone is at least partially filled.

The narrowing space may preferably be at least partially filled with a potting compound.

It may be advantageous if the layer, for example the potting compound layer, extends to the surface of the at least one energy storage element and into the narrowing space.

The atomic-level join may be a direct atomic-level join. The direct atomic-level join may preferably be a direct atomic-level join of a molded element material present at the receiving zone to the received section.

A direct atomic-level join of the at least one energy storage element to the at least one molded element may advantageously be produced for example by forming the at least one molded element in the presence of the at least one energy storage element at a surface of the at least one energy storage element. To this end the at least one energy storage element may preferably be at least partially introduced into a mold in which molded element is produced or form a part of the mold in which the molded element is produced. The molded element may preferably be produced by the process described herein.

The energy storage device may preferably comprise at least two temperature-control zones, each of which can conduct a respective temperature-control fluid. The at least one energy storage element may extend through the at least one molded element. One of the temperature-control zones may extend on one side of the at least one molded element. The other temperature-control zone may extend on the other side of the at least one molded element.

It may be advantageous when the energy storage device comprises more than two temperature-control zones, each of which can conduct a respective temperature-control fluid. A molded element may preferably extend between respective sets of two of the temperature-control zones.

The energy storage device may comprise a second molded element and the at least one energy storage element may extend through at least one temperature-control zone formed between the molded elements in such a way that a temperature-control fluid may be conducted around the energy storage element between the molded elements.

It may be particularly advantageous when a first received section of the at least one energy storage element is received in the at least one receiving zone of one of the two molded elements and a second received section of the at least one energy storage element is received in the at least one receiving zone of the other of the two molded elements.

The molded element may have a temperature-control fluid guiding section with which a temperature-control fluid conductible along a surface of the molded element may be deflected and/or a molded element transition section in which the molded element transitions from a first molded element zone to a second molded element zone.

The temperature-control fluid guiding section may comprise a molded element cutout through which a temperature-control fluid may be conducted. Via the molded element cutout a temperature-control fluid may be conductible for example from one surface of the molded element through the molded element to a second surface of the molded element or be conductible, for example recyclable, through a channel in the molded element.

The first molded element zone may comprise the at least one receiving zone for receiving the at least one section of the temperature-controllable element. The second molded element zone may comprise at least a second receiving zone for receiving at least a second section of the same temperature-controllable element. A temperature-control fluid may be conductible between the two molded element zones around a temperature-control section of the temperature-controllable element.

It is preferable when a surface of an energy storage element at a received section does not differ from a surface of the energy storage element at another section. A received section is preferably distinct from another section solely in that the received section of an energy storage element may be received in a receiving zone of a molded element. The term “received section” is thus used especially to refer to the surface region of the energy storage element which is received in a receiving zone of a molded element.

The energy storage device may preferably comprise at least one housing element. The energy storage device may particularly preferably comprise a housing.

The housing may comprise a plurality of housing elements, for example wall elements, one or more bottom elements and one or more cover elements.

The at least one molded element or at least one of the molded elements may be mounted to the housing element.

The at least one molded element or the at least one of the molded elements may preferably be joined to the housing element by an atomic-level join.

The atomic-level join to the housing element may be an indirect atomic-level join. The indirect atomic-level join may preferably be mediated by a potting compound. Alternatively, the molded element may preferably be directly joined to the housing element, for example to a surface of the housing element, by an atomic-level join. The molded element material may advantageously be directly joined to the surface of the housing element by an atomic-level join.

The direct atomic-level join of the molded element to the housing element may for example be produced by producing the molded element at a surface of the housing element. To this end the housing element may be introduced into a mold in which the molded element is produced or provide a surface of the mold in which the molded element is produced. Production may be carried out by the process described herein.

It may be particularly advantageous when the energy storage device comprises further energy storage elements and a housing which encompasses a space for receiving the energy storage elements, wherein the energy storage elements occupy a first volume fraction of the space, the at least one molded element occupies a second volume fraction of the space and a third volume fraction of the space may be occupied by a temperature-control fluid. The second volume fraction may be at least 40%, preferably at least 80%, for example at least 125%, of the third volume fraction. When the energy storage device comprises one or more further molded elements the volumes of all molded elements are altogether fed into the calculation of the second volume fraction.

The energy storage device may preferably contain a temperature-control fluid, wherein the density of the molded element material is lower than the density of the temperature-control fluid.

The density of the molded element material may preferably be at most 80%, for example at most 65%, of the density of the temperature-control fluid. The temperature-control fluid may preferably occupy the third volume fraction of the space.

It may be particularly advantageous when the density of the molded element material is at most 50%, particularly preferably at most 35%, for example at most 20%, of the density of the temperature-control fluid.

It was found that the invention made it possible to displace and thus render dispensable a substantial portion of the temperature-control fluid with the molded element while nevertheless ensuring efficient temperature control of the energy storage elements in the energy storage device. This can significantly reduce the weight of the energy storage device.

According to the invention, the object is achieved by a structural component according to the independent claim relating thereto.

The structural component is a structural component for a motor vehicle, wherein the structural component may preferably be a housing element for an energy storage device, for example for an energy storage device according to the invention.

The structural component has a molded element arranged on a surface of the structural component.

It is preferable when the molded element is mounted to the surface of the structural component.

It is particularly preferable when the molded element is joined to the surface of the structural component by an atomic-level join.

In connection with the structural component according to the invention the molded element may preferably be a molded element according to the invention.

In connection with the structural component according to the invention it is possible for the shape of the molded element to diverge from the shape described in connection with the molded element according to the invention.

In connection with the structural component according to the invention the molded element may comprise a molded element material having a density of at most 0.75 g/cm³, preferably at most 0.65 g/cm³, particularly preferably at most 0.55 g/cm³. The features described herein for the molded element material especially in connection with the molded element according to the invention may also form features of the molded element material when the molded element arranged at the surface of the structural component does not comprise the at least one receiving zone described in connection with the molded element according to the invention.

The atomic-level join of the molded element to the surface of the structural component may be an indirect atomic-level join. The indirect atomic-level join may preferably be mediated by a potting compound. Alternatively, the molded element may preferably be directly joined to the surface of the structural component by an atomic-level join. The molded element material may advantageously be directly joined to the surface of the structural component by an atomic-level join.

The direct atomic-level join of the molded element to the structural component may for example be produced by producing the molded element at a surface of the structural component. To this end the structural component may be introduced into a mold in which the molded element is produced or provide a surface of the mold in which the molded element is produced.

The production of the molded element may be carried out directly at the surface of the structural component by the process described herein.

The structural component may have a joining zone, wherein the molded element preferably does not extend into the joining zone.

The joining zone may be used for joining the structural component to a motor vehicle, for example joining the structural component to another structural component of the motor vehicle or to a weight-bearing component of the motor vehicle.

The structural component may have a depression. The surface of the structural component on which the molded element is arranged may be a surface of the molded element arranged in the depression.

The structural component may have a joining zone formed outside the depression. The structural component may have a plurality of joining zones formed outside the depression.

It is possible for the structural component to comprise a layer and for the layer comprised by the structural component to contain an electrically conductive material or to consist of an electrically conductive material. The layer may preferably contain aluminum, for example an aluminum foil. This may be advantageous since this makes it possible for the structural component to additionally achieve an at least partial electromagnetic shielding.

According to the invention, the object is achieved by a process according to the independent claim relating thereto.

The process is a process for producing a molded element, preferably a molded element according to the invention described herein.

Particles comprising cavities, for example pores, or precursor particles of particles comprising cavities, for example pores, are introduced into a mold and the particles or precursor particles introduced into the mold are converted into the molded element in the mold. The molded element may then be withdrawn from the mold.

The particles or precursor particles introduced into the mold may be converted into the molded element in the mold at a molding temperature. The molding temperature may preferably be at least 60° C., particularly preferably 80° C. to 300° C., for example 90° C. to 250° C. Those skilled in the art will select suitable shape-forming temperatures adapted to the composition of the particles or precursor particles.

At least a portion of the cavities may be enclosed in the particles and thus be inaccessible to a fluid surrounding the particles.

When precursor particles are introduced into the mold, cavities may be formed therein at a cavity-forming temperature. The cavity-forming temperature may preferably be at least 60° C., particularly preferably 80° C. to 300° C., for example 90° C. to 250° C. Those skilled in the art will select cavity-forming temperatures according to the composition of the precursor particles and especially taking into account the cavity-forming blowing agent that may be present in the precursor particles.

The precursor particles of particles comprising cavities, for example pores, may contain a cavity-forming, for example pore-forming, blowing agent. The cavity-forming, for example pore-forming, blowing agent may contain or be a substance which upon heating of the precursor particles is converted into a gaseous state. This makes it possible to form cavities, for example pores. The cavities, for example pores, may be completely or partially filled by the gaseous substance. Suitable cavity-forming blowing agents are described for example in U.S. Pat. No. 3,615,972.

The forming of the cavities may be carried out for example by heating. The heating may be carried out in the mold during conversion of the precursor particles into the molded element.

The process may preferably be a process for producing a molded element, wherein particles comprising cavities, for example pores, are introduced into a mold and the particles introduced into the mold are converted into the molded element in the mold. This can provide the advantage that the process conditions during conversion of the particles introduced into the mold into the molded element may be selected without taking account of conditions desired for forming cavities in precursor particles. The particles have cavities, for example pores, from the outset.

The process may preferably be a process for producing a molded element, wherein precursor particles of particles comprising cavities, for example pores, are introduced into a mold and the precursor particles introduced into the mold are converted into the molded element in the mold. This may be advantageous since the precursor particles introduced into the mold can expand to afford the molded element in the mold during conversion. The expansion may be effected by the cavity-forming blowing agent present in the precursor particles being at least partially converted into the gas phase. This allows the cavities, for example pores, to be formed in the particles, wherein the precursor particles are converted into particles comprising cavities, for example pores, which occupy a greater volume.

To convert the particles or precursor particles introduced into the mold into the molded element the temperature and/or the pressure in the mold may be elevated.

Elevating the temperature may especially ensure that the particles or precursor particles become soft at the surfaces and/or undergo partial melting. This can promote a bonding of the particles or precursor particles and thus a stability of a molded element being formed in the mold.

Elevating the pressure can ensure that the particles or precursor particles reliably also penetrate into narrow zones of the mold, for example into narrow zones of the mold in which regions of the molded element having low material thicknesses, for example the lowest material thickness described herein, are formed.

The plastic particles or plastic precursor particles described herein may advantageously be thermoplastic particles or thermoplastic precursor particles. Elevating the temperature can especially promote a bonding of particles. In the precursor particles a softening or partial melting of the thermoplastic can promote the formation of the cavities, for example pores. When the cavity-forming blowing agent is at least partially converted into the gas phase, softened and/or at least partially molten thermoplastics which surround the cavities and expand with growing cavity volumes may be formed.

It may be particularly advantageous when the particles or the precursor particles are microparticles,

wherein the volume-average particle diameter (D50) of the particles may preferably be in a range from 2.5 to 800 μm, preferably from 4 to 500 μm, for example from 10 to 300 μm, wherein the volume-average particle diameter (D50) of the precursor particles may preferably be in a range from 1 to 320 μm, preferably from 1.6 to 200 μm, for example from 4 to 120 μm.

The volume-average particle diameter (D50) may preferably be a volume-average particle diameter (D50) such as is derivable by laser light scattering measurements according to ISO 13320:2009-10.

Those skilled in the art are readily capable of producing such small particles, each comprising one or more cavities, for example pores. This also applies to associated precursor particles.

Thus for example DE 689 13 235 T2 describes a process and an apparatus for producing expandable thermoplastic microspheres and the subsequent expansion thereof.

U.S. Pat. No. 3,615,972 describes expandable thermoplastic polymer particles containing a volatile liquid blowing agent and a process for expanding these particles. U.S. Pat. No. 3,615,972 emphasizes that the diameter may be adjusted in a controlled manner in the range from about half a micrometer or less to about 0.5 cm.

It may be particularly advantageous when the particles comprising the cavities, for example the pores, are introduced into the mold, wherein the particles are preferably thermoplastic particles or, when the particles are microparticles, the microparticles are preferably thermoplastic microparticles, wherein the particles are introduced into the mold at elevated introduction pressure. The introduction pressure may be an introduction pressure of 1.1 bar to 10 bar, for example an introduction pressure of 1.2 to 3 bar. The particles introduced into the mold may be converted into the molded element in the mold by heating and/or by pressure reduction. This can help to ensure that at the introduction pressure the particles occupy a compressed state and are distributed in the mold in the compressed state and that the mold is completely occupied by the molded element being formed.

It may be advantageous when particles comprising the cavities, for example the pores, are introduced into the mold, wherein the particles are preferably thermoplastic particles or, when the particles are microparticles, the microparticles are preferably thermoplastic microparticles, wherein the particles, for example the thermoplastic particles, microparticles or thermoplastic microparticles, or a proportion of these particles comprise a bonding auxiliary. The particles or the proportion of the particles may preferably comprise the bonding auxiliary on their outer surfaces, wherein it may be advantageous when the particles introduced into the mold are converted into the molded element in the mold, thus bonding particles to one another via the bonding auxiliary.

It may be very particularly advantageous when after introduction of the particles into the mold a pressure reduction to a mold filling pressure between the introduction pressure and the ambient pressure is carried out before the conversion into the molded element by heating is carried out.

An expansion of the resulting molded element and/or of particles present therein may advantageously be effected through a pressure reduction to ambient pressure after commencement of heating, during heating and/or at elevated temperature after heating.

This makes it possible to obtain a substantially entirely closed-pored molded element which especially comprises barely any open pores accessible to a temperature-control fluid from the surface of the molded element.

The thermoplastic microparticles may for example comprise or be formed from small-celled foam structures composed of a thermoplastic material, for example polypropylene and/or polyethylene. The introduction pressure may be about 2 bar for example. The shape may be defined by a mold. The pressure may be reduced to a mold filling pressure >1 bar and <2 bar. The heating may be effected using hot steam to melt the surfaces of the particles. The particles may be expanded by further reduction of the pressure to ambient pressure.

According to the invention, the object is achieved by a use according to the independent claim relating thereto.

The use according to the invention is a use of a molded element according to the invention, of an energy storage device according to the invention and/or of a structural component according to the invention, wherein a dielectric temperature-control fluid, for example a dielectric temperature-control liquid, is brought into contact with a surface of the molded element and/or conducted along a surface of the molded element, wherein the molded element at least at this surface is permanently resistant to the dielectric temperature-control fluid. At least at this surface the molded element may preferably comprise a polyamide (PA) and/or be a polyamide molded element and/or be formed from a polyamide (PA), wherein the dielectric temperature-control fluid may preferably be a dielectric liquid, for example a dielectric oil. The term “permanently resistant” may especially have a meaning which in this regard has been described herein in connection with the molded element according to the invention.

It goes without saying that features described in connection with one subject of the invention may also form features of another subject of the invention described herein. The subjects of the invention are especially the molded element, the energy storage device, the structural component, the process for producing a molded element and the use.

The following description and the pictorial representation of exemplary embodiments relate to further preferred features and/or advantages of the invention.

### BRIEF DESCRIPTION OF THE DRAWINGS

FIG. 1: shows a perspective view of a molded element;

FIG. 2: shows a schematic sectional view of a portion of an energy storage device;

FIG. 3: shows a sectional view of a portion of a molded element;

FIG. 4: shows a view of a further molded element;

FIG. 5: shows the circumferential edge of the molded element from FIG. 4;

FIG. 6: shows the receiving zones of the molded element from FIG. 4; and

FIG. 7: shows a highly magnified schematic sectional view of a simplified representation of a molded element material.

Identical or functionally equivalent elements are provided with the same reference numerals in all of the figures.

### DETAILED DESCRIPTION OF THE DRAWINGS

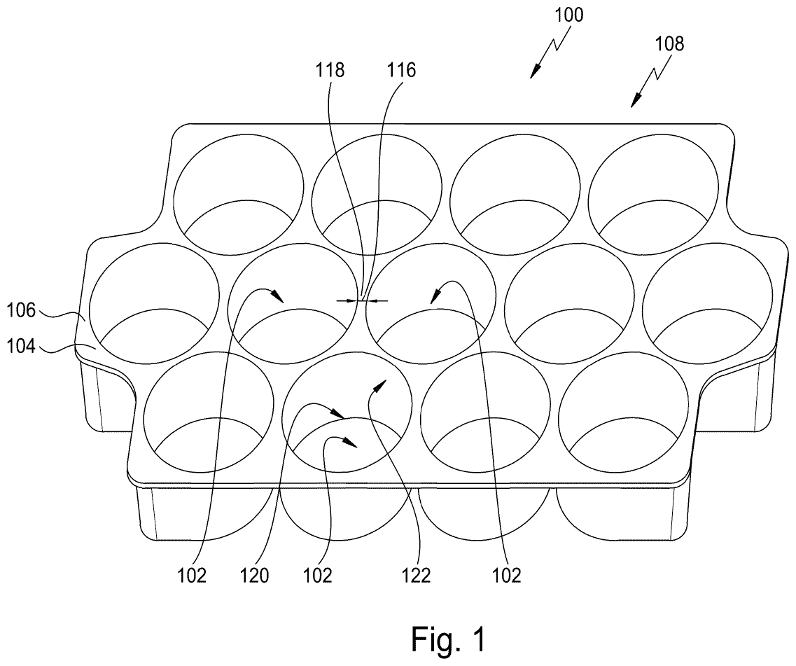

FIG. 1 shows a molded element 100. The molded element is suitable for arranging on a temperature-controllable element. The temperature-controllable element may preferably be an energy storage element, for example an electrochemical energy storage cell, in particular a battery cell.

The molded element comprises a plurality of receiving zones 102. The receiving zones 102 are each suitable for receiving at least one section of a respective temperature-controllable element in the molded element 100.

In the example shown here the molded element 100 consists entirely of a molded element material 104. The density of the molded element material 104 is preferably less than 0.55 g/cm³.

In the example shown here the molded element material 104 is a particle foam material 106 which may be a plastic particle foam material.

In the molded element 100 shown in FIG. 1 the molded element material 104 occupies the entire volume of the molded element 100. The molded element 100 shown therein is a plastic molded element 108.

The plastic molded element 108 is obtained by molding. The molding was performed by a process described herein for producing the molded element 100. This comprised introducing particles 112 comprising cavities, for example pores 110, into a mold. The particles 112 introduced into the mold were thermoplastic microparticles having closed pores, i.e. a form of plastic particles 114. They were converted into the molded element 100 in the mold by heating. The temperature was adjusted such that the thermoplastic became sufficiently soft, thus bonding the thermoplastic material on particle surfaces of adjacent particles.

It is readily apparent in FIG. 1 that the material thickness 116 of the molded element material 104 in the molded element 100 is not constant. In the example shown here a lowest material thickness 118 of the molded element material 104 is less than 4 mm.

The lowest material thickness 118 is measured between two receiving zones 102. Between the receiving zones the molded element material 104 narrows to the lowest material thickness 118.

In the molded element 100 shown in FIG. 1 the receiving zones 102 are cylindrical receiving zones 120. They each comprise a cylindrically circumferential receiving zone surface 122.

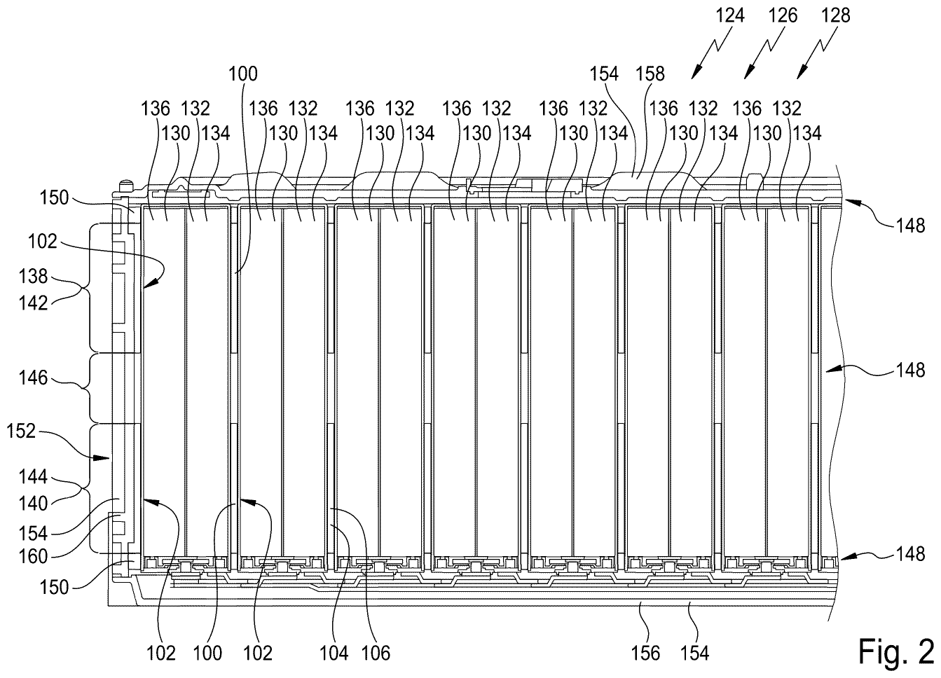

FIG. 2 shows a schematic sectional view of an energy storage device 124. The energy storage device 124 shown is an electrochemical energy storage device 126. It is a battery apparatus 128.

The energy storage device 124 shown in FIG. 2 comprises a multiplicity of energy storage elements 130. The energy storage elements 130 are electrochemical energy storage cells 132. These are battery cells 134, wherein the battery cells may be for example rechargeable lithium-ion battery cells.

Each energy storage element 130 forms a specific shape of the temperature-controllable element 136 described in connection with the invention.

The energy storage device 124 comprises two molded elements 100. Since the view shown in FIG. 2 shows the energy storage elements 130 sectioned centrally along their longitudinal axes the regions of lowest material thickness 118 arranged between the energy storage elements 130 are the only visible parts of the molded elements 100.

A respective section 138 of each energy storage element 130 is received in a respective receiving zone 102 of the one molded element 100. A respective section 140 of each energy storage element 130 is received in a respective receiving zone 102 of the other molded element 100.

Sections 138 and 140 thus represent received sections 142 and 144.

A temperature-control section 146 of each energy storage element 130 extends through a temperature-control zone 148 formed between the molded elements 100 such that a temperature-control fluid is conductible therein between the molded elements 100 and the energy storage elements 130.

Further temperature-control zones 148 are arranged at the two ends of the energy storage elements 130.

The energy storage elements 130 are each joined to the two molded elements 100 by an atomic-level join. The atomic-level joins are indirect atomic-level joins which are in each case mediated by a potting compound 150.

The energy storage device 124 shown in FIG. 2 comprises a housing 152. The housing 152 is constructed from a plurality of housing elements 154.

Since the section shown in FIG. 2 shows only a portion of the energy storage device 124, FIG. 2 shows only a left-hand wall element 160 in addition to the bottom element 156 and the cover element 158.

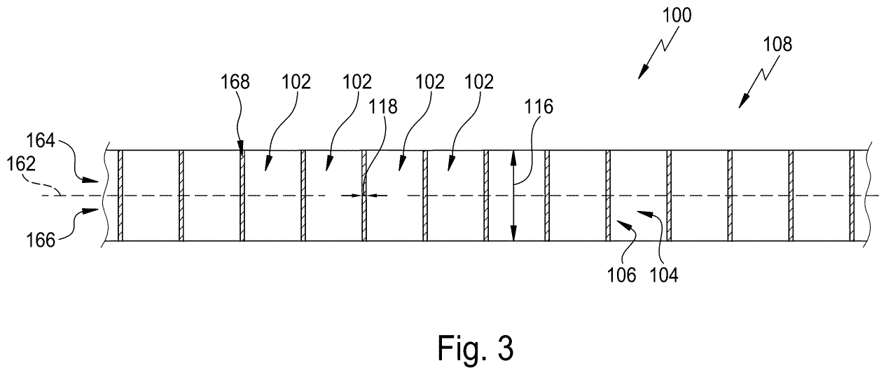

FIG. 3 shows a portion of a flat molded element 100 in a sectional representation. The notional central plane 162 indicated with a dashed line defines two halves 164 and 166, each of which occupies a volume of 50% of the volume of the molded element 100.

Receiving zones 102 are apparent in FIG. 3 as well. The receiving zones 102 are each suitable for receiving a section of a respective temperature-controllable element 136 in the molded element 100. The molded element 100 shown in FIG. 3 is also a plastic molded element 108.

The molded element shown in FIG. 3 comprises wall zones 168. The wall zones 168 are each arranged between two directly adjacent receiving zones 102. Similarly to the rest of the molded element 100 the wall zones 168 are made of the molded element material 104 which may be a particle foam material 106 for example.

FIG. 3 also shows a lowest material thickness 118 previously described in connection with the molded element 100 from FIG. 1. The lowest material thickness 118, shown in FIG. 3, is measured in the central plane 162 of the flat molded element 100. In the molded element 100 shown in FIG. 3 a material thickness 116 measured orthogonally to the central plane 162 of the flat molded element 100 is markedly greater than the lowest material thickness 118 measured in the central plane 162 of the flat molded element 100.

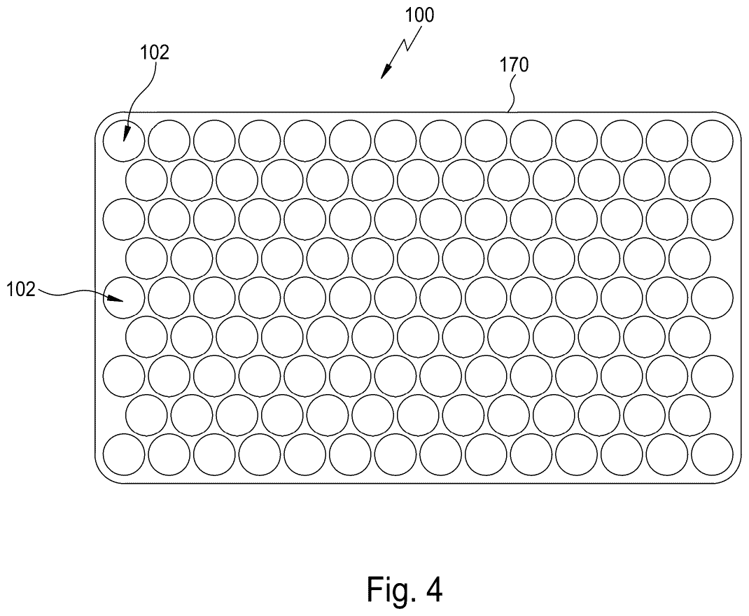

FIG. 4 shows a further molded element 100. In FIG. 4 the viewing direction of the observer is aligned parallel to the receiving direction in which temperature-controllable elements 136 not shown in FIG. 4, for example battery cells, may be received in the depicted receiving zones 102. The cylindrical receiving zones 102 therefore appear as circles in the view of FIG. 4.

FIG. 4 also shows a circumferential edge 170 of the flat molded element.

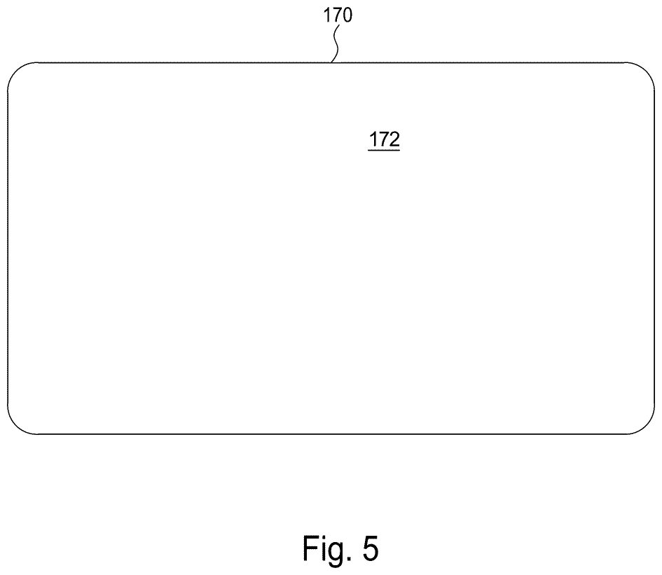

FIG. 5 shows exclusively the circumferential edge 170. The circumferential edge 170 defines a molded element total area 172.

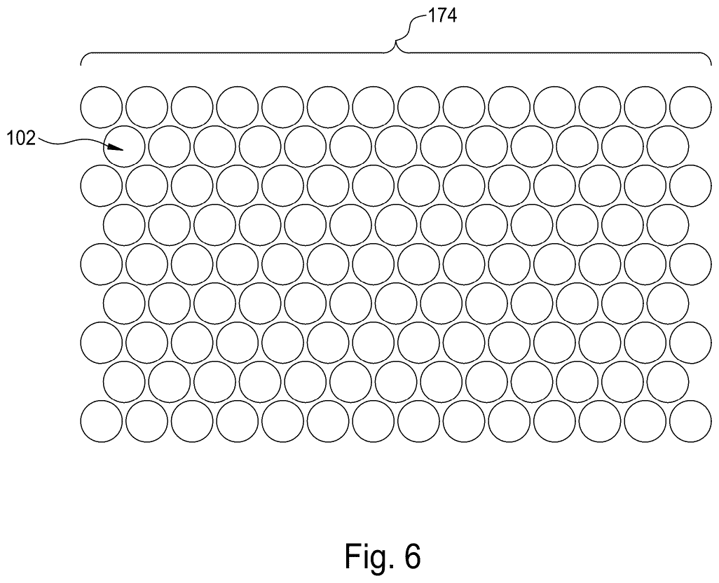

FIG. 6 shows only the receiving zones 102 from FIG. 4. The receiving zones 102 altogether occupy a receiving zone total area 174.

It is readily apparent from FIG. 4 that the molded element 100 comprises receiving zones 102 within the circumferential edge 170 and that their receiving zone total area 174 is more than 75% of the molded element total area 172.

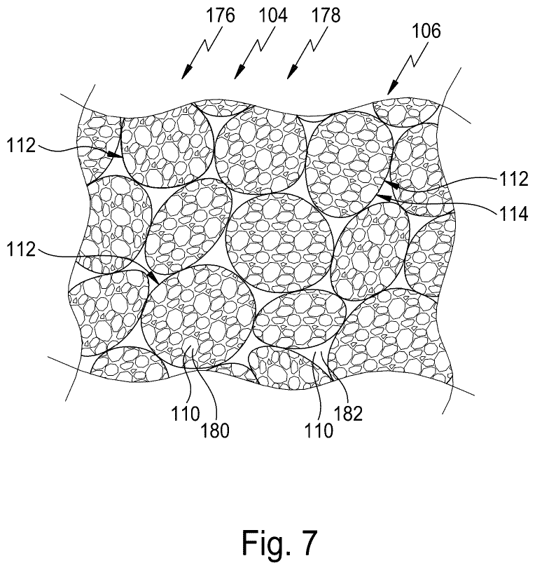

FIG. 7 shows a schematic representation of a section through a simplified molded element material 104. The section is highly magnified. The molded element material 104 shown therein is a molded element plastic material 176.

The molded element material 104 comprises cavities. The cavities are partly pores 110, 180 that are inaccessible to a surrounding fluid. Consequently, a proportion of the pores 110, 180 is closed and inaccessible to a temperature-control fluid.

FIG. 7 shows only a portion of the molded element material 104 shown in section. It is apparent from FIG. 7 that a proportion of the pores 110, 182 may be open and/or accessible to a temperature-control fluid. Depending on the constitution of the surfaces of the molded element these pores 110, 182 may be accessible to a temperature-control fluid not only via the sectional area shown but also starting from the surface of the molded element 100 not shown in FIG. 7.

When the surfaces of the molded element are closed, for example sealed, the pores 110, 182 are connected to one another only within the molded element material and only open in that respect but not accessible to a temperature-control fluid.

When the surfaces of the molded element are open, for example unsealed, the pores 110, 182 are connected to one another within the molded element material and, in addition, also open and accessible to a temperature-control fluid.

The molded element material 104 contains particles 112 which are plastic particles 114. The particles 112 are melted together at their surfaces.

Closed pores 110, 180 of the molded element material 104 which are inaccessible to a temperature-control fluid may optionally be surrounded by pores 110, 182 of the molded element material 104 which are open and/or accessible to a temperature-control fluid. The molded element material 104 may be a particle foam material 106. At least a portion of the pores 110, 182 of the molded element material 104 which may optionally be open and accessible to a temperature-control fluid extends around the particles 112. The particles 112 comprise at least a portion of the pores 110, 180 which are closed and/or inaccessible to temperature-control fluid.

The particles 112 comprise the pores 110. The particle foam material 106 is composed of multi-celled particles.

The molded element plastic material 176 is a particle foam material 106 which may also be referred to as particle foam 178.

List of reference numerals

| | |
|---|---|
| 100 | Molded element |
| 102 | Receiving zone |
| 104 | Molded element material |
| 106 | Particle foam material |
| 108 | Plastic molded element |
| 110 | Pore |
| 112 | Particle |
| 114 | Plastic particle |
| 116 | Material thickness |
| 118 | Lowest material thickness |
| 120 | Cylindrical receiving zone |
| 122 | Receiving zone surface |
| 124 | Energy storage device |
| 126 | Electrochemical energy storage device |
| 128 | Battery apparatus |
| 130 | Energy storage element |
| 132 | Electrochemical energy storage cell |
| 134 | Battery cell |
| 136 | Temperature-controllable element |
| 138, 140 | Section |
| 142, 144 | Received section |
| 146 | Temperature-control section |
| 148 | Temperature-control zone |
| 150 | Potting compound |
| 152 | Housing |
| 154 | Housing element |
| 156 | Bottom element |
| 158 | Cover element |
| 160 | Wall element |
| 162 | Central plane |
| 164, 166 | Half |
| 168 | Wall zone |
| 170 | Edge |
| 172 | Molded element total area |
| 174 | Receiving zone total area |
| 176 | Molded element plastic material |
| 178 | Particle foam |
| 180 | Closed pores |
| 182 | Open pores |

1. A molded element for arranging on a temperature-controllable element,
the molded element comprising:
at least one receiving zone for receiving at least one section of the temperature-controllable element in the molded element; and
a molded element material having a density of at most 0.75 g/cm³.

2. The molded element as claimed in claim 1, wherein
a lowest material thickness of the molded element material is at most 4 mm.

3. The molded element as claimed in claim 1, wherein
the density of the molded element material and the lowest material thickness of the molded element material are sufficiently low to ensure a fineness of the molded element calculated by multiplying the density by the lowest material thickness of at most 0.15 g/cm².

4. The molded element as claimed in claim 2, wherein
the number of receiving zones comprised by the molded element is at least two and the lowest material thickness is a lowest material thickness measured between two immediately adjacent receiving zones.

5. The molded element as claimed in claim 4, wherein
the molded element is a flat molded element and the lowest material thickness is measured in a central plane of the flat molded element, and
the central plane divides the flat molded element into two halves which each occupy a volume of 50% of the volume of the molded element.

6. The molded element as claimed in claim 1, wherein
the molded element is a flat molded element and the lowest material thickness is measured orthogonally to a central plane of the flat molded element, and/or
the central plane divides the flat molded element into two halves which each occupy a volume of 50% of the volume of the molded element, and/or the molded element is a flat molded element, and/or
a circumferential edge of the flat molded element defines a molded element total area and inside the circumferential edge the molded element has receiving zones whose receiving zone total area is at least 75% or at least 80% of the molded element total area.

7. The molded element as claimed in claim 1, wherein
the molded element material contains particles and the particles comprise cavities and/or the molded element material is a particle foam material, and/or
the molded element material is a molded element plastic material and the molded element plastic material contains plastic particles, and
the plastic particles comprise cavities.

8. The molded element as claimed in claim 7, wherein
particles of the molded element material or of the particle foam material or the plastic particles of the molded element plastic material comprise a bonding auxiliary, and/or
the particles of the molded element material or of the particle foam material or the plastic particles of the molded element plastic material comprise a bonding auxiliary on their outer surfaces.

9. The molded element as claimed in claim 7, wherein
a plastic of the molded element plastic material and/or of the plastic particles is a polyamide.

10. The molded element as claimed in claim 8, wherein
the bonding auxiliary is selected from bonding auxiliaries which allow bonding of the particles or the plastic particles to one another or to the at least one section of the temperature-controllable element at a temperature at which the particles or plastic particles are stable, and/or
the bonding auxiliary is a 2-component bonding material which includes or consists of a resin particle component and a hardener component, and/or
the bonding auxiliary is a polyamide.

11. The molded element as claimed in claim 6, wherein
a proportion of the cavities is closed and/or inaccessible to a temperature-control fluid.

12. The molded element as claimed in claim 1, wherein
the molded element is permanently resistant to at least one dielectric temperature-control fluid.

13. An energy storage device comprising:
at least one energy storage element; and
said molded element as claimed in claim 1, wherein
at least one section of the at least one energy storage element is received in the at least one receiving zone of the molded element.

14. The energy storage device as claimed in claim 13, wherein
the energy storage device comprises a temperature-control zone in which a temperature control fluid may be conducted, and
a received section of the at least one energy storage element is received in the at least one receiving zone of the molded element and a temperature-control section of the at least one energy storage element extends into the at least one temperature-control zone or through the at least one temperature-control zone.

15. The energy storage device as claimed in claim 13, wherein
the at least one energy storage element is joined to the at least one molded element by an atomic-level join, and/or
the received section is joined to the receiving zone by an atomic-level join.

16. The energy storage device as claimed in claim 13, wherein
the energy storage device comprises at least two temperature-control zones, each of said at least two temperature-control zones conducts a respective temperature-control fluid,
the at least one energy storage element extends through the at least one molded element,
one of the temperature-control zones extends on one side of the molded element, and
the other temperature-control zone extends on the other side of the molded element.

17. The energy storage device as claimed in claim 13, wherein
the energy storage device comprises at least one housing element.

18. The energy storage device as claimed in claim 13, wherein
the at least one molded element or at least one of the molded elements is mounted to the housing element.

19. The energy storage device as claimed in claim 13, wherein
the energy storage device comprises energy storage elements and a housing which encompasses a space for receiving the energy storage elements,
the energy storage elements occupy a first volume fraction of the space, the at least one molded element occupies a second volume fraction of the space and a third volume fraction of the space may be occupied by a temperature-control fluid, and
the second volume fraction is at least 40% of the third volume fraction.

20. The energy storage device as claimed in claim 13, wherein
the energy storage device contains a temperature-control fluid,
the density of the molded element material is lower than the density of the temperature-control fluid, and/or
the density of the molded element material is at most 80% of the density of the temperature-control fluid.

21. A structural component for a motor vehicle, wherein
the structural component has said molded element according to claim 1 arranged on a surface of the structural component.

22. A process for producing a molded element as claimed in claim 1, wherein
particles comprising cavities or precursor particles of particles comprising cavities are introduced into a mold, and
the particles or precursor particles introduced into the mold are converted into the molded element in the mold.

23. The process as claimed in claim 22, wherein
the particles or the precursor particles are microparticles.

24. The process as claimed in claim 22, wherein
the particles comprising cavities are introduced into the mold,
the particles are thermoplastic particles or thermoplastic microparticles, and
the particles are introduced into the mold at an elevated introduction pressure, preferably at an introduction pressure of 1.1 bar to 10 bar or 1.2 to 3 bar, and
the particles introduced into the mold are converted into the molded element in the mold by heating and/or by pressure reduction.

25. The process as claimed in claim 22, wherein
the particles comprising cavities are introduced into the mold,
the particles are thermoplastic particles or thermoplastic microparticles,
the thermoplastic particles or the thermoplastic microparticles or a proportion of the thermoplastic particles or a proportion of the thermoplastic microparticles comprise a bonding auxiliary on any location or on outer surfaces.

26. The process as claimed in claim 24, wherein
after introduction of the particles into the mold a pressure reduction to a mold filling pressure between the introduction pressure and the ambient pressure is carried out before the conversion into the molded element by heating is carried out.
